(19) United States
(12) Patent Application Publication
(10) Pub. No.: US 2016/0352605 A1
(43) Pub. Date: Dec. 1, 2016

(54) SYSTEMS AND METHODS FOR DISTANCE BOUNDING TO AN AUTHENTICATED DEVICE

(71) Applicant: QUALCOMM Incorporated, San Diego, CA (US)

(72) Inventors: Jeremy Robin Christopher O'Donoghue, Wokingham (GB); John Geoffrey Bernard Hillan, Alton (GB); Stephen Frankland, Horsham (GB)

(21) Appl. No.: 14/948,087

(22) Filed: Nov. 20, 2015

Related U.S. Application Data
(60) Provisional application No. 62/168,579, filed on May 29, 2015.
(60) Provisional application No. 62/185,456, filed on Jun. 26, 2015.

(51) Int. Cl. H04L 12/26; H04W 12/06; H04L 9/08; H04L 29/06

(52) U.S. Cl. CPC H04L 43/0864; H04L 63/08; H04W 12/06; H04L 9/0838

(57) ABSTRACT

A method for determining a distance upper bound by a verifier device is described. The method includes authenticating a target device. The method also includes establishing a shared key with the target device. The method further includes sending a bounding sequence encrypted with the shared key to the target device. The method additionally includes performing a distance upper bound determination procedure with the target device based on the bounding sequence.

### RELATED APPLICATIONS

This application is related to and claims priority from U.S. Provisional Patent Application Ser. No. 62/185,456, filed Jun. 26, 2015, for “SYSTEMS AND METHODS FOR DISTANCE BOUNDING TO AN AUTHENTICATED DEVICE.” This application is also related to and claims priority from U.S. Provisional Patent Application Ser. No. 62/168,579, filed May 29, 2015, for “SYSTEMS AND METHODS FOR DETERMINING AN UPPER BOUND ON THE DISTANCE BETWEEN DEVICES.”

### TECHNICAL FIELD

The present disclosure relates generally to communications. More specifically, the present disclosure relates to systems and methods for the accurate determination of an upper bound on the distance to an authenticated device.

### BACKGROUND

Advances in technology have resulted in smaller and more powerful personal computing devices. For example, there currently exist a variety of portable personal computing devices, including wireless computing devices, such as portable wireless telephones, personal digital assistants (PDAs) and paging devices that are each small, lightweight, and can be easily carried by users. More specifically, the portable wireless telephones, for example, further include cellular telephones that communicate voice and data packets over wireless networks. Many such cellular telephones are being manufactured with relatively large increases in computing capabilities, and as such, are becoming tantamount to small personal computers and hand-held PDAs. Further, such devices are being manufactured to enable communications using a variety of wired and wireless communication technologies. For example devices may perform cellular communications, wireless local area network (WLAN) communications, near field communication (NFC), fiber optic communication, etc.

In some scenarios, communication between a verifier device and a target device may rely on authenticating the other device. However, security may be enhanced if an accurate upper bound on the distance between devices is known. Benefits may be realized by determining a distance upper bound to an authenticated device.

### SUMMARY

A method by a verifier device is described. The method includes authenticating a target device. The method also includes establishing a shared key with the target device. The method further includes sending a bounding sequence encrypted with the shared key to the target device. The method additionally includes performing a distance upper bound determination procedure with the target device based on the bounding sequence.

The encrypted bounding sequence may be sent to the target device over a secure channel upon authenticating the target device and establishing the shared key. The bounding sequence may be a random value or a sequence of random values.

A processing time multiplier for a target device response may be determined by the bounding sequence or a transformation of the bounding sequence. The processing time multiplier may indicate an amount of time that the target device delays responding to a challenge sent by the verifier device.

The distance upper bound may be an upper bound on the distance between the verifier device and the target device. Performing the distance upper bound determination procedure may include measuring a round-trip time to send a challenge to the target device and receive a response that is delayed by a processing time multiplier determined by the bounding sequence. The distance upper bound determination procedure may also include calculating the distance upper bound using the measured round-trip time and the processing time multiplier.

Performing the distance upper bound determination procedure may include measuring a first round-trip time to receive a first response from the target device corresponding to a first challenge sent to the target device. A second round-trip time to receive a second response from the target device corresponding to a second challenge sent to the target device may be measured. The target device may scale a processing time for the second response by a processing time multiplier indicated by the bounding sequence or a transformation of the bounding sequence. A transit time measurement may be determined based on the first round-trip time, the second round-trip time and the processing time multiplier. The distance upper bound may be determined by multiplying the transit time measurement by the speed of light.

A physical layer of the verifier device may send the encrypted bounding sequence. A bounding layer of the verifier device may perform the distance upper bound determination procedure.

A verifier device is also described. The verifier device includes a processor, a memory in communication with the processor, and instructions stored in the memory. The instructions are executable by the processor to authenticate a target device. The instructions are also executable to establish a shared key with the target device. The instructions are further executable to send a bounding sequence encrypted with the shared key to the target device. The instructions are additionally executable to perform a distance upper bound determination procedure with the target device based on the bounding sequence.

A method by a target device is also described. The method includes authenticating a verifier device. The method also includes establishing a shared key with the verifier device. The method further includes receiving a bounding sequence encrypted with the shared key from the verifier device. The method additionally includes performing a distance upper bound determination procedure with the verifier device based on the bounding sequence.

The encrypted bounding sequence may be received from the verifier target device over a secure channel upon authenticating the verifier device and establishing the shared key. The method may also include decrypting the bounding sequence using the shared key.

The method may also include determining a processing time multiplier for the target device response based on the bounding sequence or a transformation of the bounding sequence. The processing time multiplier may indicate an amount of time that the target device delays responding to a challenge received from the verifier device.

Performing the distance upper bound determination procedure may include receiving, from the verifier device, a challenge that is associated with a processing time multiplier determined by the bounding sequence or a transformation of the bounding sequence. A response that is delayed by the processing time multiplier may be sent to the verifier device.

A physical layer of the target device may receive the encrypted bounding sequence. A bounding layer of the target device may perform the distance upper bound determination procedure.

A target device is also described. The target device includes a processor, a memory in communication with the processor, and instructions stored in the memory. The instructions are executable by the processor to authenticate a verifier device. The instructions are also executable to establish a shared key with the verifier device. The instructions are further executable to receive a bounding sequence encrypted with the shared key from the verifier device. The instructions are additionally executable to perform a distance upper bound determination procedure with the verifier device based on the bounding sequence.

### BRIEF DESCRIPTION OF THE DRAWINGS

FIG. 1 is a block diagram illustrating one configuration of a communication system;

FIG. 2 is a flow diagram illustrating a method for distance bounding to an authenticated device;

FIG. 3 is a flow diagram illustrating another method for distance bounding to an authenticated device;

FIG. 4 is a sequence diagram illustrating a payment transaction;

FIG. 5 is a sequence diagram illustrating an example of a relay attack;

FIG. 6 is a block diagram illustrating a detailed configuration of a verifier device and a target device configured for distance bounding to an authenticated device;

FIG. 7 is a sequence diagram illustrating an implementation of distance bounding to an authenticated device;

FIG. 8 is a block diagram illustrating an example of a relay attack on a distance bounding system;

FIG. 9 is a sequence diagram illustrating one approach to calculating transit time by a verifier device;

FIG. 10 is a sequence diagram illustrating another approach to calculating transit time by a verifier device; and

FIG. 11 illustrates certain components that may be included within an electronic device.

### DETAILED DESCRIPTION

In certain situations, it is advantageous for a verifier device to be able to determine an upper bound for the distance to a target device. For example, a payment system may be experiencing a man-in-the-middle attack or a relay attack by one or more malicious devices. In this case, it is desirable to ensure that a verifier device is obtaining distance bound information from an authenticated target device, and not a malicious device.

Signal strength measurements tend to have a wide variance that makes accurate determination of distance hard to accomplish. Furthermore, by playing with the transmitter it is possible for a malicious device to pretend to be closer than the actual separation.

According to the systems and methods described herein, a verifier device and a target device may authenticate each other and establish a shared key. Using the shared key, the verifier device may provide an encrypted bounding sequence to the target device. The bounding sequence may indicate a processing time multiplier that the target device may use to delay responding to one or more challenges sent by the verifier device. From a transit time measurement, the verifier device may determine an upper bound on the distance to the target device.

If the bounding sequence that indicates the delay value, or sequence of delay values, is known only to the verifier device and the target device, the verifier device has a very high level of confidence that it is receiving the information it uses to calculate the distance upper bound from an authentic target device, and not from an attacker.

It should be noted that some communication devices may communicate wirelessly and/or may communicate using a wired connection or link. For example, some communication devices may communicate with other devices using an Ethernet protocol. The systems and methods disclosed herein may be applied to communication devices that communicate wirelessly and/or that communicate using a wired connection or link. In one configuration, the systems and methods disclosed herein may be applied to a communication device that communicates with another device using near-field communication (NFC).

The detailed description set forth below in connection with the appended drawings is intended as a description of exemplary implementations of the disclosure and is not intended to represent the only implementations in which the disclosure may be practiced. The term “exemplary” used throughout this description means “serving as an example, instance, or illustration,” and should not necessarily be construed as preferred or advantageous over other exemplary implementations. The detailed description includes specific details for the purpose of providing a thorough understanding of the exemplary implementations of the disclosure. In some instances, some devices are shown in block diagram form.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

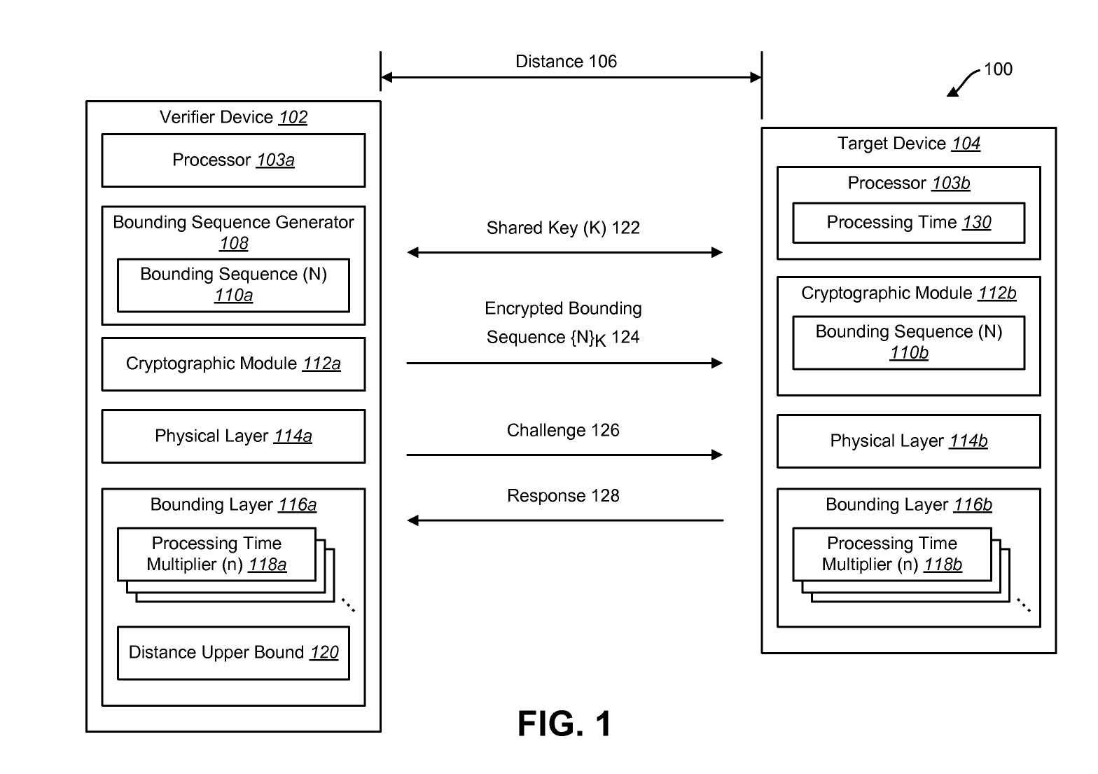

FIG. 1 is a block diagram illustrating one configuration of a communication system 100. The communication system 100 may include a verifier device 102 and a target device 104. The verifier device 102 or the target device 104 may also be referred to as an electronic communication device, mobile device, mobile station, subscriber station, client, client station, user equipment (UE), remote station, access terminal, mobile terminal, terminal, user terminal, subscriber unit, reader, a passive device (e.g., tag), etc. Examples of devices include laptop or desktop computers, card readers, cellular phones, smart phones, wireless modems, e-readers, tablet devices, gaming systems, etc. Some of these devices may operate in accordance with one or more industry standards.

The verifier device 102 and the target device 104 may communicate using one or more communication technologies. These communication technologies may include wired communication technologies and wireless communication technologies.

The verifier device 102 and the target device 104 may communicate using one or more communication technologies that operate at the speed of light. These technologies may include, but are not limited to, radio frequency (RF), visible light (“LiFi”), microwave, infrared communication, and electrical current flow.

In one configuration, the verifier device 102 and the target device 104 may communicate using inductively coupled communication. In one implementation of inductively coupled communication, the verifier device 102 and the target device 104 may use near field communication (NFC). In another implementation, the verifier device 102 and the target device 104 may use radio-frequency identification (RFID).

In another configuration, the verifier device 102 and the target device 104 may operate in accordance with certain industry standards, such as Third Generation Partnership Project (3GPP) Long Term Evolution (LTE) standards. Other examples of standards that a communication device may comply with include Institute of Electrical and Electronics Engineers (IEEE) 802.11a, 802.11b, 802.11g, 802.11n and/or 802.11ac (e.g., Wireless Fidelity or “Wi-Fi”) standards, Bluetooth, IEEE 802.16 (e.g., Worldwide Interoperability for Microwave Access or “WiMAX”) standards, Code Division Multiplier Access (CDMA) 2000 1× (referred to herein as “1×”, may also be referred to as IS-2000 or 1×RTT) standards, Evolution-Data Optimized (EVDO) standards, Interim Standard 95 (IS-95), High Data Rate (HDR), High Rate Packet Data (HRPD), evolved High Rate Packet Data (eHRPD), radio standards and others. WWAN may also include Wireless Metropolitan Area Networking (WMAN) standards and High-Speed Downlink Packet Access (HSDPA) standards. Wired communication standards may include Ethernet and universal serial bus (USB) standards. While some of the systems and methods disclosed herein may be described in terms of one or more standards, this should not limit the scope of the disclosure, as the systems and methods may be applicable to many systems and/or standards.

The verifier device 102 and the target device 104 may be separated by a distance 106. In certain situations, it may be advantageous to be able to determine an upper bound for the distance 106 from a verifier device 102 to a target device 104. This becomes especially important when attempting to verify that a device being presented to another device for a transaction is physically close in order to thwart relay attacks.

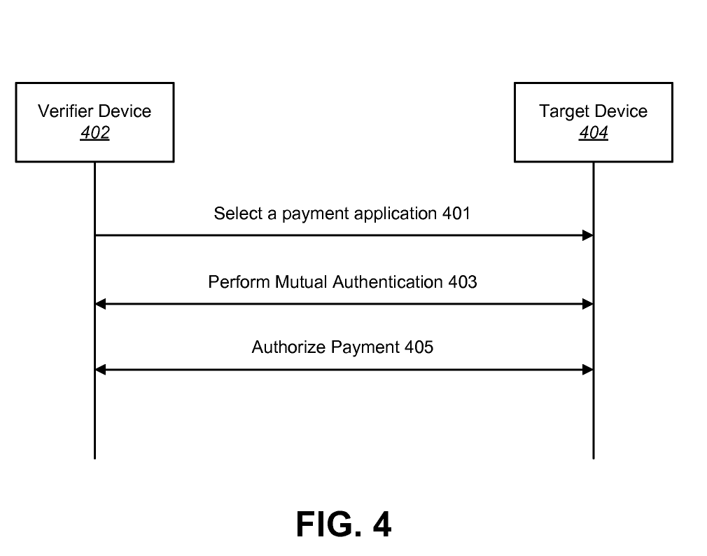

It may also be beneficial to authenticate the target device 104 to which the distance upper bound 120 is being demonstrated, which may be of interest in addressing certain types of relay attacks. As an example, consider a payment system in which a payment instrument, such as a contactless credit card or smart phone (e.g., target device 104), may be interacting with a payment card reader (e.g., verifier device 102). Such a system is described in connection with FIG. 4.

Using mechanisms such as public key cryptography or shared secrets, the verifier device 102 may authenticate that the target device 104. Furthermore, normal security protocols, such as for building access or payment, only verify that a device being presented is able to respond correctly to one or more challenges.

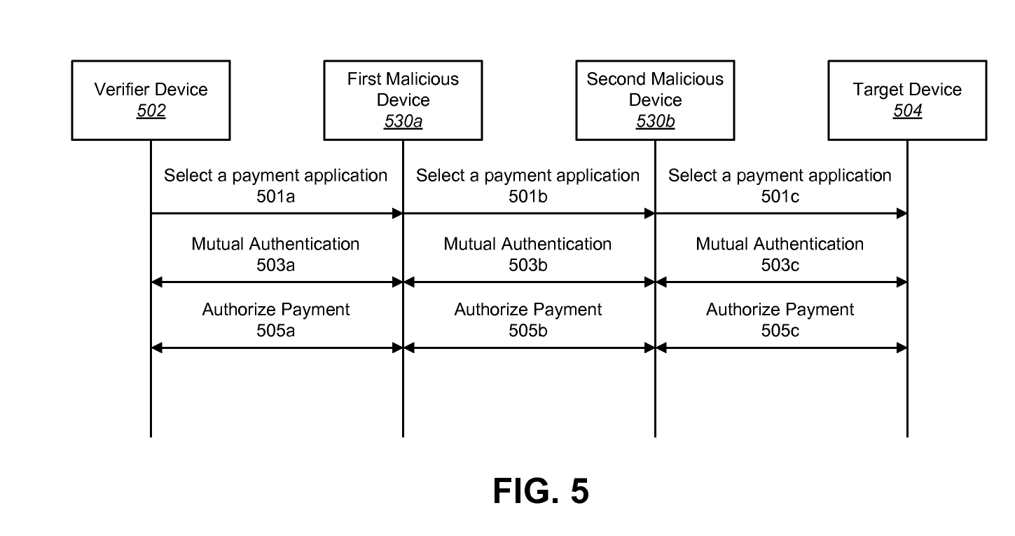

However, it is possible to circumvent these security measures by relaying the challenge to an authenticated (e.g., genuine) device, then relaying the response back to the device under attack. When considering that all that would be needed is a pair of malicious devices (e.g., smart phones) with a downloaded program to perform this relay, the potential number of attacks is huge. FIG. 5 illustrates an example of a relay attack.

Current systems are vulnerable to this form of fraud. This vulnerability applies to both contact based and contactless systems. The types of relay attacks that have been described would be rendered significantly more difficult if the distance 106 between the verifier device 102 (e.g., payment card reader) and the target device 104 (e.g., payment instrument) was known to be less than some upper bound, as this would place severe physical constraints on the location of an attacker.

A number of mechanisms have been proposed but all suffer from drawbacks. For example, signal strength measurements tend to have a wide variance that makes accurate determination of distance 106 hard to accomplish. Furthermore, by manipulating a transmitter, it is possible to pretend to be closer than the actual separation.

Another approach is to use the round-trip delay for a signal. Since nothing can travel faster than the speed of light, a signal (e.g., radio or light signal) can reliably be used to place an upper bound on the distance 106 (i.e., distance upper bound 120) from the verifier device 102 to the target device 104. The target device 104 might be closer, but it cannot be farther away than the distance upper bound 120.

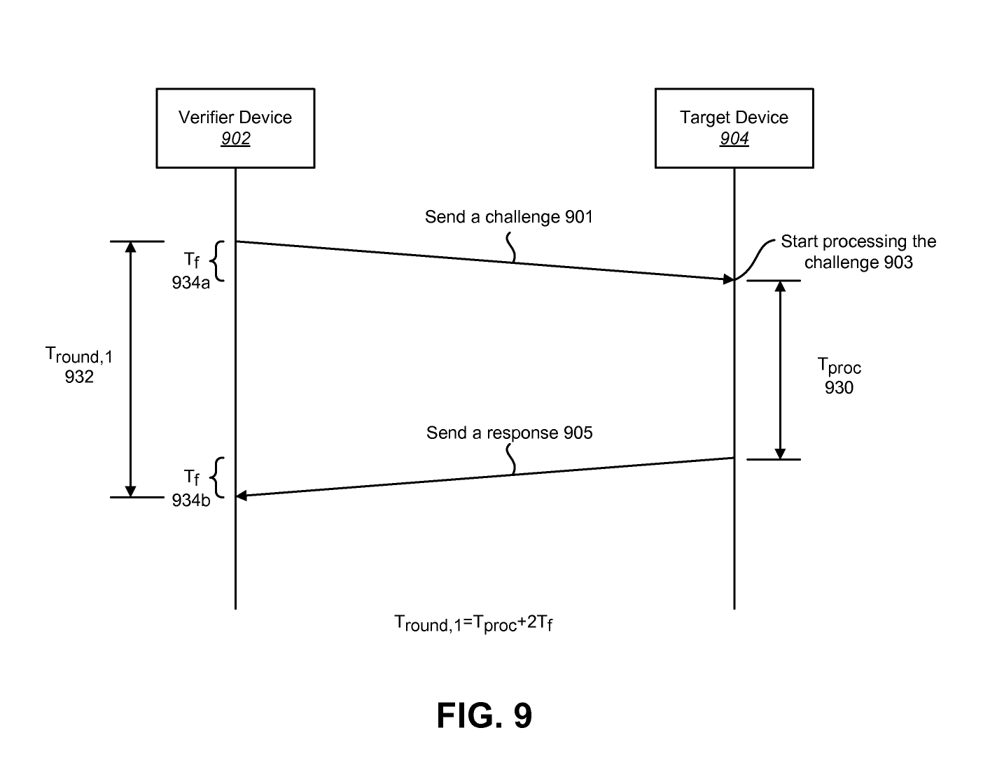

The main drawback to this approach is that the transit times are extremely short, especially when trying to establish location to human dimensions. Even a 1 nanosecond (ns) round trip corresponds to a separation of 15 centimeters (cm). This means that any processing delay in the remote device can quickly swamp the transit time and lead to huge uncertainty in the distance 106 measurement. FIG. 9 shows this situation.

The systems and methods described herein provide for determining a distance upper bound 120 to an authenticated target device 104. The described systems and methods eliminate the effects of the processing delay in the target device 104. This may allow for far more accurate distance 106 measurements.

The verifier device 102 and target device 104 may perform mutual authentication and may perform a distance upper bound 120 determination procedure. Therefore, not only can the verifier device 102 be certain of the authenticity of the target device 104 with which it is communicating, but also that the target device 104 with which it is communicating is within a known distance upper bound 120.

According to the systems and methods described herein, the verifier device 102 may mutually authenticate with a target device 104. The verifier device 102 may establish a communication channel with the target device 104 that provides secrecy and integrity. The verifier device 102 then may establish a distance upper bound 120 with the target device 104 independent of processing time.

The verifier device 102 may include a processor 103a, a cryptographic module 112a, a physical layer 114a, a bounding layer 116a and a bounding sequence generator 108. The processor 103a may execute software code on the verifier device 102.

The cryptographic module 112a may perform cryptographic operations. These cryptographic operations may include encryption and decryption using a shared key, generation of cryptographic hashes and signing of data.

The physical layer 114a may be responsible for sending and receiving data during the normal operation of the verifier device 102. For example, the physical layer 114a may send data to and receive data from the target device 104 via a wired connection or wireless link.

The bounding sequence generator 108 may generate a bounding sequence (N) 110a. The bounding sequence 110a may be a value or a sequence of values. In an implementation, the bounding sequence 110a may be random or pseudo-random in nature. For example, the bounding sequence 110a may be a random value or a sequence of random values. In an implementation, the bounding sequence generator 108 may be a random number source.

The bounding sequence 110a may be used to determine a multiplier to the processing time of the target device 104. The bounding sequence 110a may indicate the processing time multiplier 118 for the target device 104. This may be done implicitly or explicitly. In one implementation, the bounding sequence 110a may be a label from which the processing time multiplier 118 is determined. In another implementation, the bounding sequence 110a may explicitly provide be the actual processing time multipliers 118.

The bounding layer 116a may perform a distance upper bound 120 determination procedure with the target device 104 based on the bounding sequence 110a or a transformed bounding sequence 110a. The distance upper bound 120 is an upper bound on the distance 106 between the verifier device 102 and the target device 104. The distance upper bound 120 determination procedure is described in more detail below.

The target device 104 may include a processor 103b, a cryptographic module 112b, a physical layer 114b and a bounding layer 116b. The processor 103b may execute software code on the target device 104. The cryptographic module 112b may perform cryptographic operations on the target device 104. The physical layer 114b may be responsible for sending and receiving data during the normal operation of the target device 104.

The verifier device 102 and the target device 104 may perform mutual authentication. In other words, the verifier device 102 may authenticate the target device 104 and the target device 104 may authenticate the verifier device 102. In an example, the authentication may be performed using a Diffie-Hellman key exchange. In another example, Fiat-Shamir procedure may be used for authentication. Additional authentication examples include Secure Sockets Layer (SSL) using public key infrastructure (PKI) certificates and Kerberos.

Upon authentication, the verifier device 102 and the target device 104 may establish a shared key (K) 122. The shared key 122 may be an ephemeral key. The mechanisms used for authentication and establishing the shared key 122 may be chosen to be resistant to man-in-the-middle attacks.

As described above, the bounding sequence generator 108 of the verifier device 102 may generate the bounding sequence 110a. It should be noted that the bounding sequence 110a may be generated before or after performing mutual authentication and exchanging the shared key 122. Some or all of the value(s) of the bounding sequence 110a may be used as a multiplier to the processing time of the target device 104. Therefore, the bounding sequence 110a indicates the processing time multiplier 118a that is used by the target device 104.

The verifier device 102 may encrypt the bounding sequence 110a. For example, the cryptographic module of the verifier device 102 may encrypt the bounding sequence 110a using the shared key 122.

The verifier device 102 and the target device 104 may use a channel providing secrecy and integrity to transfer the encrypted bounding sequence ({N}_{K}) 124 from the verifier device 102 to the target device 104. In an implementation, the secure channel may be established between the physical layer 114a of the verifier device 102 and the physical layer 114b of the target device 104. Therefore, the encrypted bounding sequence ({N}_{K}) 124 may be transferred from the verifier device 102 to the target device 104 using the physical layers 114a,b.

Upon receiving the encrypted bounding sequence ({N}_{K}) 124, the cryptographic module 112b of the target device 104 may decrypt the bounding sequence 110b using the shared key 122. Upon decrypting the bounding sequence 110b, the target device 104 has the same bounding sequence 110 as the verifier device 102.

The target device 104 may determine a processing time multiplier 118b based on the bounding sequence 110b or a transformed bounding sequence 110b. For example, the processor 103b on the target device 104 may load some or all of the decrypted bounding sequence 110b into its bounding layer 116b. At this point, both the bounding layer 116a of the verifier device 102 and the bounding layer 116b of the target device 104 have the same sequence of processing time multipliers 118.

As described above, the bounding sequence 110 may indicate the processing time multipliers 118 implicitly or explicitly. For example, the bounding sequence 110 may provide the actual processing time multipliers 118. Alternatively, the bounding sequence 110 may be a modified value from which the processing time multipliers 118 are determined. For example, the bounding sequence 110 may be reversed, inverted, scrambled by some known sequence or encrypted. The target device 104 may then derive the actual processing time multipliers 118b from the modified value of the bounding sequence 110.

In another implementation, the bounding sequence 110 may be further transformed at each end (i.e., by the verifier device 102 and the target device 104). This may further protect an unencrypted bounding sequence 110 as well as the encrypted value (over the air). Therefore, the bounding sequence 110 may be further encrypted by performing an additional transform of the transmitted bounding sequence 110. In this implementation, the verifier device 102 and the target device 104 may use the transformed bounding sequence 110 instead of the transmitted bounding sequence 110 for performing distance bounding.

The verifier device 102 and the target device 104 may perform a distance upper bound 120 determination procedure based on the bounding sequence 110 or a transformed bounding sequence 110. In an implementation, the distance upper bound 120 determination procedure may include sending a challenge 126 from the verifier device 102 to the target device 104. The challenge 126 may be a message that includes a question for the target device 104 to answer.

Upon receiving the challenge 126, the target device 104 may delay sending a response 128 by the processing time multiplier 118b associated with the challenge 126. After waiting for the delay, the target device 104 may send a response 128 to the verifier device 102. In an implementation, the response 128 may include an answer to the question included in the challenge 126.

It should be noted that the verifier device 102 may send a number of challenges 126 and the target device 104 may respond to these challenges 126 according to their respective processing time multipliers 118b. Each of the responses 128 may be delayed by a different processing time multiplier 118b, as indicated by the bounding sequence 110b or the transformed bounding sequence 110b.

The verifier device 102 may measure the round-trip time to send a challenge 126 to the target device 104 and receive a response 128 that is delayed by the processing time multiplier 118a. The verifier device 102 may then calculate the distance upper bound 120 to the target device 104 using the measured round-trip time and the processing time multiplier 118a.

In an implementation, the target device 104 may perform the distance upper bound 120 determination procedure by first measuring a first round-trip time. The first round-trip time may include the transit time for sending a first challenge 126 to the target device 104, a processing time 130 by the target device 104 and the transit time to receive a first response 128 from the target device 104.

The processing time 130 may be the amount of time that the target device 104 takes to process a challenge 126 received from the verifier device 102. In other words, the processing time 130 is the amount of time that the target device 104 takes to process a received challenge 126 and generate a response 128. The first round-trip time may be expressed according to Equation (1).

T_{round,1}=T_{proc}+2·T_{f} (1)

In Equation (1), T_{round,1} is the first round-trip time, T_{proc} is the processing time 130 for the target device 104 to process the first challenge 126 and T_{f} is the transit time that is multiplied by 2 due to the verifier device 102 sending the first challenge 126 and receiving the first response 128.

The verifier device 102 may measure a second round-trip time that includes the transit time for sending a second challenge 126 to the target device 104, a processing time multiplier (n) 118 applied by the target device 104 and the transit time to receive a second response 128 from the target device 104. Upon receiving the second challenge 126, the target device 104 may scale (e.g., delay) the processing time 130 by the processing time multiplier (n) 118 before responding to the second challenge 126. The second round-trip time may be expressed according to Equation (2).

T_{round,n}=n·T_{proc}+2·T_{f} (2)

In Equation (2), T_{round,n} is the second round-trip time, and n is the processing time multiplier 118b for the target device 104 to process the second challenge 126. Once again, the transit time T_{f} is multiplied by 2 due to the verifier device 102 sending the second challenge 126 and receiving the second response 128.

The verifier device 102 may determine a transit time measurement based on the first round-trip time, the second round-trip time and the processing time multiplier (n) 118. If n represents the scale factor for the target device 104 (e.g., a card) to use in its processing time delay, then a transit time measurement T_{f} may be determined according to the following equations. Multiplying the first round-trip time by n results in

$$\begin{matrix}n \cdot {T}_{round , 1} = n \cdot {T}_{proc} + 2 n \cdot {T}_{f} . & ( 3 ) \\ \begin{matrix}n \cdot {T}_{round , 1} - {T}_{round , n} = n \cdot {T}_{proc} + 2 n \cdot {T}_{f} - n \cdot {T}_{proc} - 2 \cdot {T}_{f} \\ = 2 n \cdot {T}_{f} - 2 \cdot {T}_{f} \\ = 2 {T}_{f} ( n - 1 )\end{matrix} & ( 4 ) \\ {T}_{f} = \frac{n \cdot {T}_{round , 1} - {T}_{round , n}}{2 ( n - 1 )} & ( 5 )\end{matrix}$$

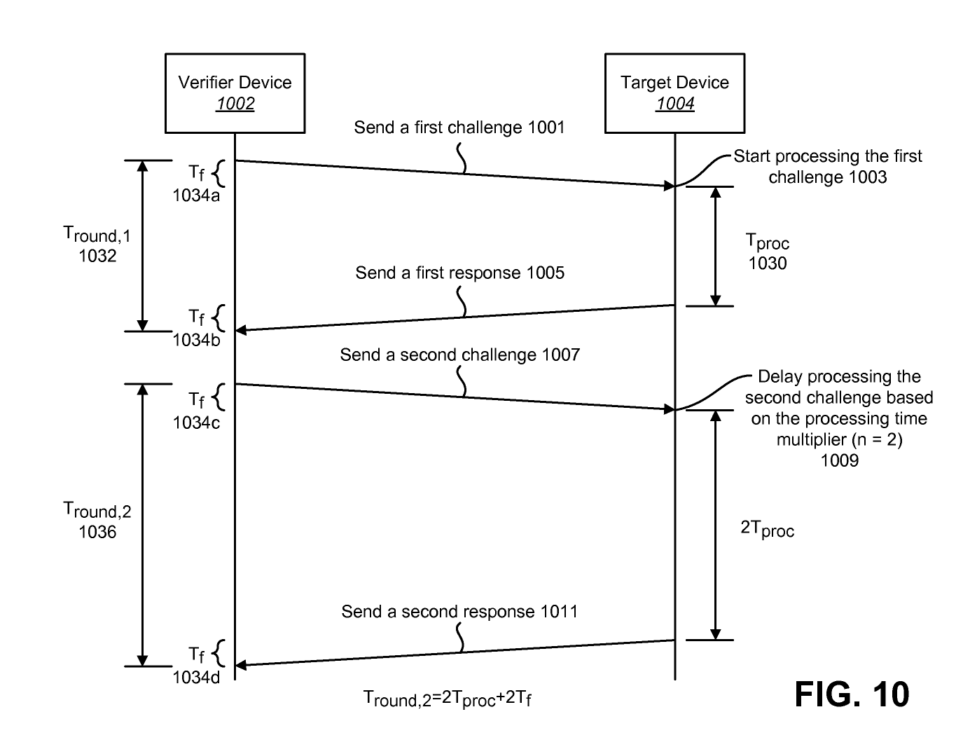

It should be noted that according to Equation (5), the verifier device 102 (e.g., reader/writer) may calculate the transit time independently of the actual processing time 130 of the target device 104. In other words, the verifier device 102 need not know the processing time 130 of the target device 104 to determine the transit time measurement. Although the target device 104 must be able to scale its processing time 130 accurately, this approach does not rely on this processing time 130 being short. FIG. 10 illustrates an example where the processing time multiplier 118 (n) is 2.

The verifier device 102 may determine a distance upper bound 120 between the verifier device 102 and the target device 104 based on the transit time measurement. Once the transit time measurement T_{f} is determined to the desired accuracy, the verifier device 102 may determine the distance upper bound 120 by multiplying the transit time measurement by the speed of light (c). The distance upper bound 120 may be expressed as T_{f}·c.

This distance upper bound 120 may be an upper bound of a measure of the distance 106 (or separation) between the verifier device 102 and the target device 104. Therefore, the verifier device 102 and the target device 104 may be closer than the distance upper bound 120, but the verifier device 102 and the target device 104 cannot be farther apart.

It should be noted that according to Equations (1)-(5), it is assumed that the transit time out and the transit time back are the same. Therefore, 2·T_{f} is the total transit time. If the processing time 130 of the target device 104 is large, then it may be possible that the verifier device 102 and the target device 104 could have moved relative to each other. This scenario will not be a practical issue for a device being held by a user assuming a practical processing time 130. However, even in extreme cases where the target device 104 processing time 130 is slow and the distance 106 between the verifier device 102 and the target device 104 is changing quickly, the verifier device 102 will determine an average of the device separation. In this case, the time measurements are going to show the distance 106 as changing. This can be used as another criterion for refusing to communicate with the target device 104.

It should also be noted that by repeating the round-trip time measurements multiple times, minor fluctuations in the processing delay may be averaged out, improving the accuracy of the transit time measurement still further. Therefore, in an implementation, the verifier device 102 may determine the distance upper bound 120 based on at least one additional transit time measurement in which the target device 104 delays its response according to the processing time multiplier 118. The processing time multiplier 118b that is used by the target device 104 for these additional transit time measurements may be indicated by the bounding sequence 110b.

In this implementation, the verifier device 102 may measure at least one additional round-trip time to receive a response from the target device 104. The response from the target device 104 may or may not be delayed by the processing time multiplier 118, as indicated by the bounding sequence 110a. Furthermore, the processing time multiplier 118 used in the one or more round-trip time measurements may be the same value, or may be a different value. In other words, the processing time multiplier 118, in this implementation, may be a sequence of values that are applied for a given round-trip time measurement. For example, in one round-trip time measurement the processing time multiplier 118 may be 2, while in another round-trip time measurement the processing time multiplier 118 may be 3.

The verifier device 102 may then determine at least one additional transit time measurement using the at least one additional round-trip time. For each round-trip time measurement, the verifier device 102 may determine a transit time measurement according to Equation (5). The verifier device 102 may determine an average transit time measurement using each of the multiple transit time measurements. The verifier device 102 may determine the distance upper bound 120 by multiplying the average transit time measurement by the speed of light.

The processing time multiplier 118 may be known by the verifier device 102 and the target device 104 but not known to other devices. As described above, the processing time multiplier 118 may be indicated by the bounding sequence 110 that is exchanged by the verifier device 102 and the target device 104.

It is extremely difficult for a malicious device to defeat this approach by adjusting its processing time 130 to pretend to be closer than it actually is. To make the response 128 arrive at the verifier device 102 at the correct time, the scaling of the processing time 130 is not simply doubling. Since the target device 104 does not know the distance 106 to the verifier device 102, it does not know T_{f}, so it cannot determine the necessary processing time 130 it needs to use in order to pretend to be at a shorter distance.

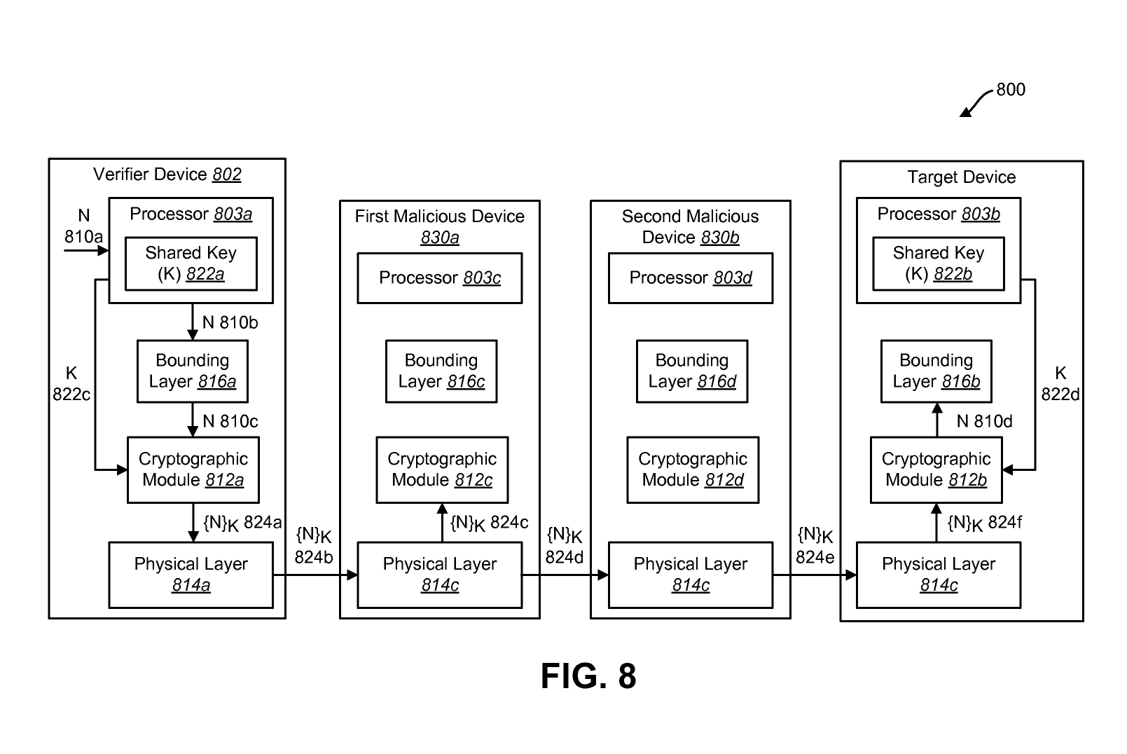

Since the described systems and methods provide for the use of multiple values of the processing time multiplier 118, which can be randomly determined and then encrypted, it is not possible for an attacking device to know the sequence of processing time multipliers 118 that will be used for any transaction. The behavior of the described systems and methods in the case of a payment scheme in the presence of a relay attack is described in connection with FIG. 8.

Only a device that has the shared key (K) 122 will be able to decrypt the bounding sequence (N) 110, and thus be able to determine the sequence of processing time multipliers 118 that are to be used during the distance upper bound 120 determination step.

Furthermore, only a target device 104 that has the shared key (K) 122 and is physically close to the verifier device 102 will be able to respond correctly to the one or more challenges 126 from the verifier device 102. Making the bounding sequence (N) 110 a random sequence from which some or all values of the processing time multipliers 118 are chosen may significantly reduce the probability that a malicious device could determine appropriate fake processing delay values.

As discussed above, it is computationally difficult for an attacker to calculate suitable fake time multiples to make a malicious device able to pass the bounds check. However, it is possible that an advanced attacker, armed with knowledge of the bounding sequence 110 and with knowledge of all of the distances involved could calculate a set of fake values for the processing time multipliers 118, given sufficient time and computing resources. Where the bounding sequence 110 is a random value, or a sequence of random values determined when the link is established, the time available to calculate fake values is hugely reduced.

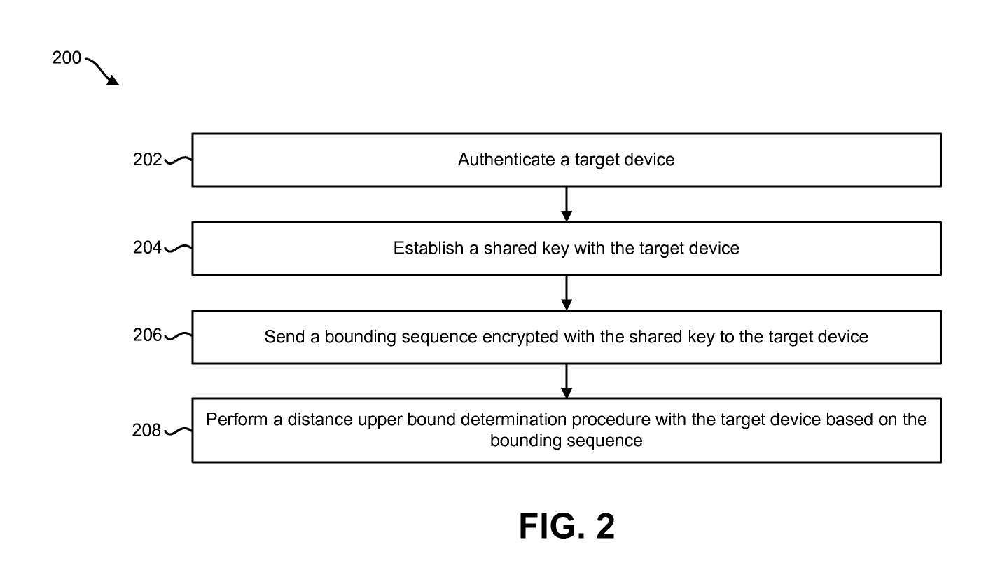

FIG. 2 is a flow diagram illustrating a method 200 for distance bounding to an authenticated device. The method 200 may be performed by a verifier device 102 that is in communication with a target device 104. For example, the verifier device 102 may be a reader device and the target device 104 may be a card device. The verifier device 102 may perform the method 200 to determine a distance upper bound 120 to the target device 104.

The verifier device 102 may authenticate 202 the target device 104. The authentication may be used to establish that the target device 104 is the actual device that it claims to be and not an imposter device.

Upon authenticating the target device 104, the verifier device 102 may establish 204 a shared key 122 with the target device 104. This may be accomplished as described in connection with FIG. 1.

The verifier device 102 may send 206 a bounding sequence 110 encrypted with the shared key 122 to the target device 104. The encrypted bounding sequence 124 may be sent 206 to the target device 104 over a secure channel upon authenticating the target device 104 and establishing the shared key 122.

The bounding sequence 110 may be a random value or a sequence of random values. The bounding sequence 110 may be used to determine a processing time multiplier 118 for the target device 104. The processing time multiplier 118 indicates an amount of time that the target device 104 delays responding to a challenge 126 received from the verifier device 102.

The verifier device 102 may perform 208 a distance upper bound 120 determination procedure with the target device 104 based on the bounding sequence 110. The distance upper bound 120 may be the upper bound on the distance 106 between the verifier device 102 and the target device 104.

The verifier device 102 may measure a round-trip time to send a challenge 126 to the target device 104 and receive a response 128 that is delayed by a processing time multiplier 118 determined by the bounding sequence 110. The verifier device 102 may calculate the distance upper bound 120 using the measured round-trip time and the processing time multiplier 118.

In an implementation, the verifier device 102 may measure a first round-trip time to receive a first response 128 from the target device 104 corresponding to a first challenge 126 sent to the target device 104. The verifier device 102 may measure a second round-trip time to receive a second response 128 from the target device 104 corresponding to a second challenge 126 sent to the target device 104. The target device 104 may scale the processing time for the second response 128 by a processing time multiplier 118 indicated by the bounding sequence 110.

The verifier device 102 may determine a transit time measurement based on the first round-trip time, the second round-trip time and the processing time multiplier 118. For example, the verifier device 102 may determine a transit time measurement according to Equation (5). The verifier device 102 may then determine the distance upper bound 120 by multiplying the transit time measurement by the speed of light.

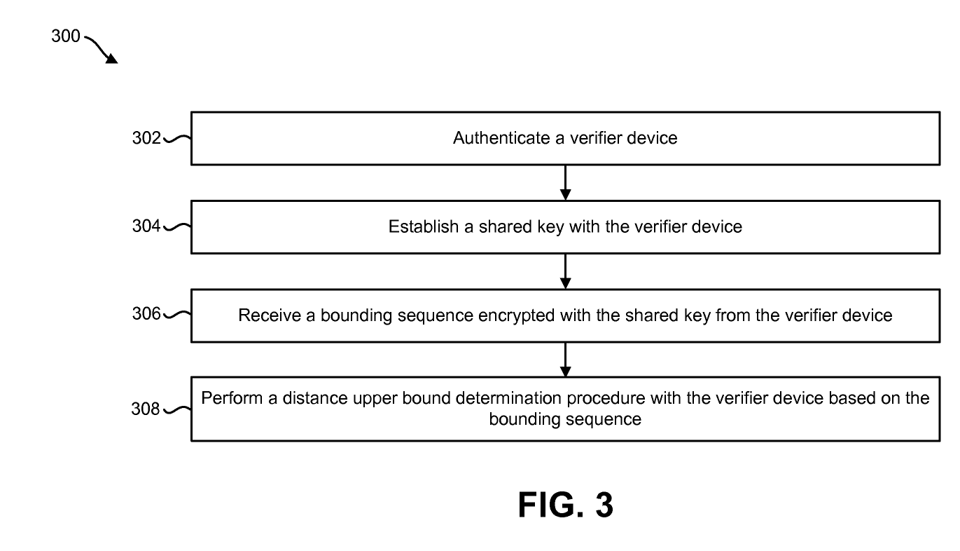

FIG. 3 is a flow diagram illustrating another method 300 for distance bounding to an authenticated device. The method 300 may be performed by a target device 104 that is in communication with a verifier device 102. The target device 104 may perform the method 300 to facilitate the verifier device 102 in determining a distance upper bound 120 to the target device 104.

The target device 104 may authenticate 302 the verifier device 102. The authentication may establish that the verifier device 102 is the actual device that it claims to be and not an imposter device.

Upon authenticating the verifier device 102, the target device 104 may establish a shared key 122 with the verifier device 102. This may be accomplished as described in connection with FIG. 1.

The target device 104 may receive 306 a bounding sequence 110 encrypted with the shared key 122 from the verifier device 102. The encrypted bounding sequence 124 may be received 306 from the verifier device 102 over a secure channel upon authenticating the verifier device 102 and establishing the shared key 122.

The bounding sequence 110 may be a random value or a sequence of random values. The bounding sequence 110 may be used to determine a processing time multiplier 118 for the target device 104. The processing time multiplier 118 indicates an amount of time that the target device 104 delays responding to a challenge 126 received from the verifier device 102.

The target device 104 may perform 308 a distance upper bound 120 determination procedure with the verifier device 102 based on the bounding sequence 110. For example, the target device 104 may receive a challenge 126 from the verifier device 102. The challenge 126 may be associated with a processing time multiplier 118 determined by the bounding sequence 110. The target device 104 may send a response 128 to the verifier device 102 that is delayed by the processing time multiplier 118. The verifier device 102 may determine the distance upper bound 120 as described in connection with FIG. 2.

FIG. 4 is a sequence diagram illustrating a payment transaction. A verifier device 402 may be in communication with a target device 404. In an implementation, the verifier device 402 may be a payment card reader and the target device 404 may be a contactless credit card or smartphone.

The verifier device 102 may send 401 a select payment application message to the target device 104. The verifier device 102 and the target device 104 may perform 403 mutual authentication. Upon performing mutual authentication, the verifier device 102 and the target device 104 may authorize 405 payment.

FIG. 5 is a sequence diagram illustrating an example of a relay attack. In an implementation, the verifier device 502 may be a payment card reader, a reader/writer or a point-of-sale (POS) terminal. The target device 504 may be a contactless credit card or smartphone.

A first malicious device 530a (e.g., smart phone) may be in close proximity to the verifier device 502. A second malicious device 530b (e.g., smart phone) may be in close proximity to the target device 504.

The verifier device 502 and the target device 504 may be separated by a sufficient distance 106 that they cannot communicate directly with each other. For example, if the verifier device 502 and the target device 504 communicate using NFC or RFID, then communication may be limited to a few centimeters.

In this example, the target device 504 may be used for building access or payment. The security protocols used by the verifier device 502 may only verify that a device being presented is able to respond correctly to a number of challenges 126.

The first malicious device 530a and the second malicious device 530b may circumvent these security protocols. The pair of malicious devices 530a,b may be capable of relaying the contactless protocol between the verifier device 502 and the target device 504. In other words, the malicious devices 530a,b may relay the challenges 126 and responses 128. For example, the malicious devices 530a,b may be interposed in the system, as might happen if, for example, a stolen credit card or payment-enabled smart phone was being used to make a fraudulent payment.

The first and second malicious devices 530a,b may relay payment application messages 501a-c between the verifier device 502 and the target device 504. For example, upon initiating a transaction, the verifier device 502 may send a select payment application message to the first malicious device 530a. The first malicious device 530a may forward 501b the select payment application message to the second malicious device 530b. The second malicious device 530b may forward 501c the select payment application message to the target device 504. The target device 504 may send a response back to the verifier device 502 via the first and second malicious devices 530a,b.

The verifier device 502 and the target device 504 may then perform mutual authentication 503 via the malicious devices 530a,b. The first and second malicious devices 530a,b may relay mutual authentication messages 503a-c between the verifier device 502 and the target device 504. For example, the verifier device 502 may send a challenge 126 to the first malicious device 530a, which relays the challenge 126 to the second malicious device 530b. The second malicious device 530b may relay the challenge 126 to the target device 504. The target device 504 may respond to this challenge 126 and send a response 128 back to the verifier device 502 under attack (via the first and second malicious devices 530a,b). Therefore, this attack uses genuine cryptographic functions of a payment card and genuine authorizations.

The verifier device 502 and the target device 504 may then authorize payment. The payment authorization messages 505a-c may be relayed via the malicious devices 530a,b. As far as the verifier device 502 is concerned, it sent the challenge(s) 126 and it received the correct response(s) 128, which satisfied the security protocols.

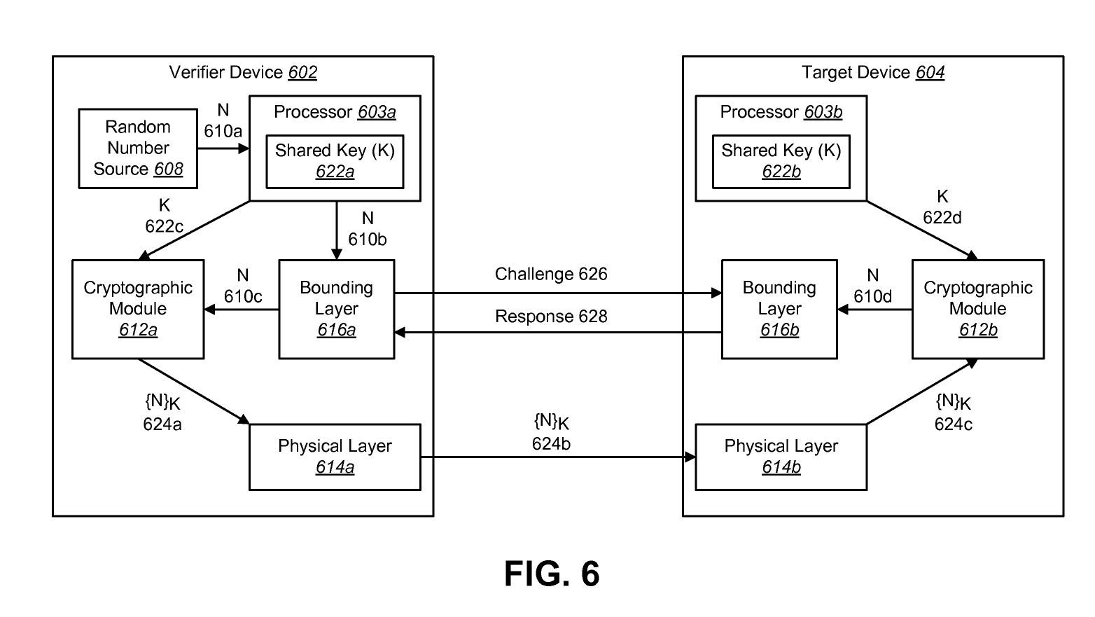

FIG. 6 is a block diagram illustrating a detailed configuration of a verifier device 102 and a target device 104 configured for distance bounding to an authenticated device. The verifier device 102 and the target device 104 of FIG. 6 may be implemented in accordance with the verifier device 102 and the target device 104 of FIG. 1, respectively.

The verifier device 602 may include a processor 603a, a cryptographic module 612a, a bounding layer 616a and a physical layer 614a. The target device 604 may also include a processor 603b, a cryptographic module 612b, a bounding layer 616b and a physical layer 614b.

The verifier device 602 and the target device 604 may perform mutual authentication. For example, the verifier device 602 and the target device 604 may use public key cryptography or shared secrets to establish a shared key (K) 622a,b. The mechanisms used by the verifier device 602 and the target device 604 to establish the shared key 622 may be resistant to man-in-the-middle attacks.

The processor 603a of the verifier device 602 may generate a bounding sequence (N) 610a. In an implementation, the bounding sequence 610a may be random or pseudo-random in nature. The bounding sequence (N) 610a may be generated from a random number source 608. The bounding sequence (N) 610a may be a random value (or sequence of random values). Some or all of the value(s) N 610 may be used as a multiplier to the processing time 130. In other words, the bounding sequence 610 may indicate the processing time multiplier 118 for the target device 604.

The verifier device 602 may establish a channel providing secrecy and integrity to transfer N 610 to the target device 604. In an implementation, the processor 603a may load some or all of the bounding sequence (N) 610b to the bounding layer 616a. The bounding layer 616a may then provide the bounding sequence (N) 610c to the cryptographic module 612a. The processor 603a may also provide the shared key (K) 622c to the cryptographic module 612a, which may encrypt the bounding sequence 610 using the shared key (K) 622c.

The cryptographic module 612a may provide the encrypted bounding sequence ({N}_{K}) 624a to the physical layer 614a of the verifier device 602. The verifier device 602 may send the encrypted bounding sequence ({N}_{K}) 624b to the physical layer 614b of the target device 604. The physical layer 614b of the target device 604 then provides the encrypted bounding sequence ({N}_{K}) 624c to the cryptographic module 612b of the target device 604.

The processor 603b of the target device 604 may provide the shared key (K) 622d to the cryptographic module 612b. Using the shared key (K) 622d, the cryptographic module 612b may decrypt the bounding sequence (N) 610d.

The processor 603b of the target device 604 may load some or all of the bounding sequence (N) 610d into bounding layer 616b. At this point, the verifier device 602 and the target device 604 may have the same bounding sequence (N) 610 that may be used to determine the processing time multiplier (n) 118 used by the target device 604.

The bounding layer 616a of the verifier device 602 may send a challenge 626 to the bounding layer 616b of the target device 604. The challenge 626 may be encrypted or may be sent in plaintext form.

The target device 604 may send a response 628 to the challenge 626 using the processing time multiplier (n) 118 determined by the bounding sequence (N) 610. The verifier device 602 may calculate the distance upper bound 120 based on the processing time multiplier (n) 118 determined by the bounding sequence (N) 610. This may be accomplished as described in connection with FIG. 1.

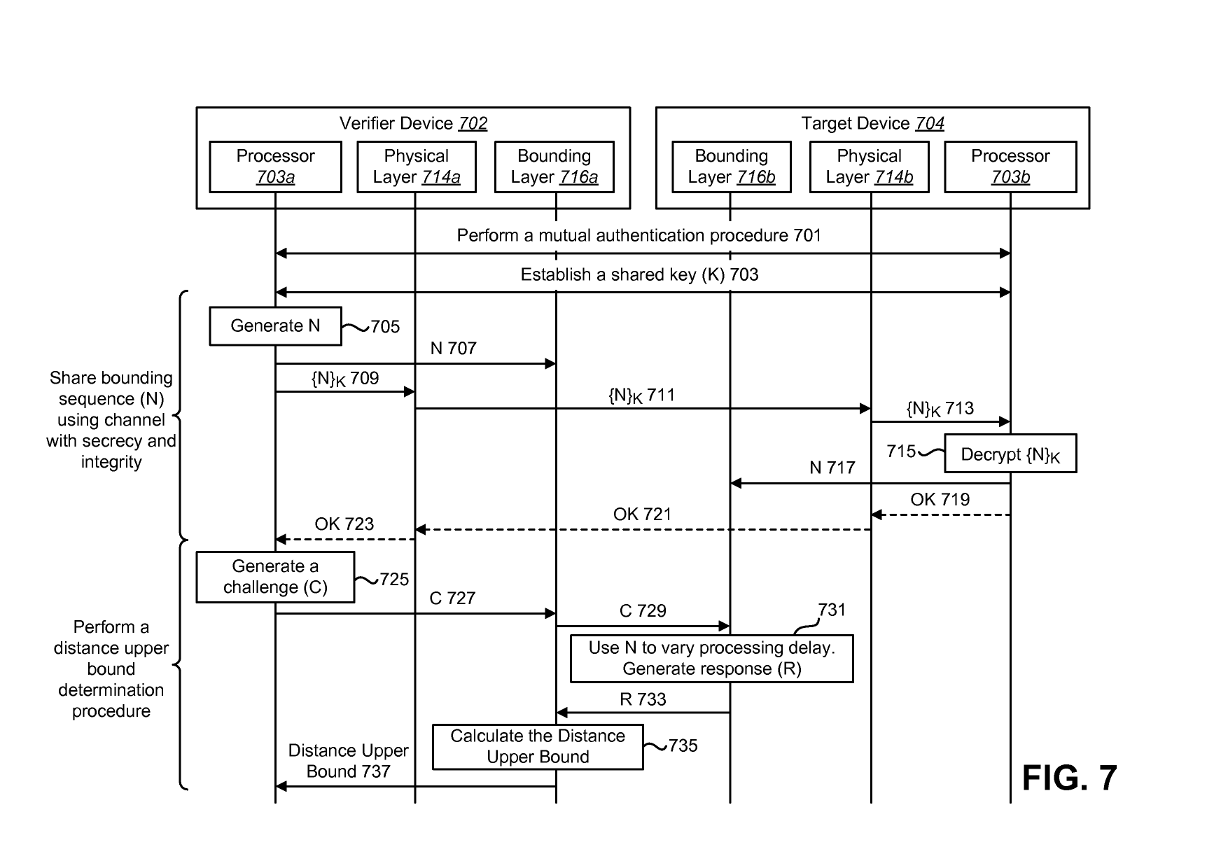

FIG. 7 is a sequence diagram illustrating an implementation of distance bounding to an authenticated device. A verifier device 702 may communicate with a target device 704. The verifier device 702 may include a processor 703a, a physical layer 714a and a bounding layer 716a. The target device 704 may also include a processor 703b, a physical layer 714b and a bounding layer 716b.

The processor 703a of the verifier device 702 and the processor 703b target device 704 may perform 701 a mutual authentication procedure. The verifier device 702 and the target device 704 may establish 703 a shared key (K) 122.

The processor 703a of the verifier device 702 may generate 705 a bounding sequence (N) 110. The bounding sequence (N) 110 may be a value or a sequence of values. In an implementation, the bounding sequence (N) 110 may be random or pseudo-random in nature. The processor 703a may provide 707 N 110, some part of N 110, or a transformation of N 110 to the bounding layer 716a.

The verifier device 702 may share N 110 using a channel that provides secrecy and integrity. The processor 703a of the verifier device 702 may send 709 an encrypted bounding sequence ({N}_{K}) 124 to the physical layer 714a of the verifier device 702. The physical layer 714a of the verifier device 702 may send 711 {N}_{K} 124 to the physical layer 714b of the target device 704, which forwards {N}_{K} 124 to the processor 703b of the target device 704.

The processor 703b of the target device 704 may decrypt 715 {N}_{K} 124 to obtain N 110. The processor 703b on the target device 704 may load 717 some or all of the decrypted N 110 into its bounding layer 716b. Therefore, after decryption, the processor 703b may provide N 110, some part of N 110, or a transformation of N 110 to the bounding layer 716b. At this point, both bounding layers 716a,b have the same bounding sequence 110 from which the processing time multiplier (n) 118 may be determined.

The processor 703b of the target device 704 may (optionally) provide 719 an OK message to the physical layer 714b of the target device 704. The physical layer 714b of the target device 704 may (optionally) send 721 the OK message to the physical layer 714a of the verifier device 702, which may (optionally) forward 723 the OK message to the processor 703a of the verifier device 702.

The verifier device 702 may begin performing a distance upper bound 120 determination procedure. The processor 703a of the verifier device 702 may generate 725 a challenge (C) 126. The processor 703a may forward 727 the challenge 126 to the bounding layer 716a of the verifier device 702. The bounding layer 716a of the verifier device 702 may send 729 the challenge 126 to the bounding layer 716b of the target device 704. This challenge 126 can optionally be sent in a plaintext form, which may simplify implementation of the bounding layers 716a,b. The content of the challenge 126 may be used to transfer additional information, if required.

The target device 704 may use 731 the bounding sequence 110 or the transformed bounding sequence 110 to vary the processing delay on a response 128. For example, the target device 704 may determine the processing time multiplier (n) 118 using the bounding sequence 110. The target device 604 may delay the response 128 by the processing time multiplier (n) 118. The bounding layer 716b may send 733 the response 128 to the challenge 126 using scaling multiples (i.e., processing time multipliers (n) 118) for the processing time determined by the bounding sequence 110. The content of the response 128 may be used to transfer additional information, if required.

The bounding layer 716a of the verifier device 702 may receive the response 128 from the target device 704. The bounding layer 716a may calculate 735 the distance upper bound 120 using the processing time multipliers 118 determined by N 110. The bounding layer 716a may provide 737 the distance upper bound 120 to the processor 703a of the verifier device 702. If the determination of the distance upper bound 120 is within an allowed limit, then the target device 704 is now authenticated and distance bounded.

FIG. 8 is a block diagram illustrating an example of a relay attack on a distance bounding system 800. A verifier device 802 and a target device 804 may be implemented in accordance with the verifier device 102 and the target device 104 described in connection with FIG. 1.

The verifier device 802 may include a processor 803a, a cryptographic module 812a, a bounding layer 816a and a physical layer 814a. The target device 804 may also include a processor 803b, a cryptographic module 812b, a bounding layer 816b and a physical layer 814b.

In FIG. 8, a payment scheme in the presence of a relay attack is illustrated. A first malicious device 830a may include a processor 803c, a cryptographic module 812c, a bounding layer 816c and a physical layer 814c. A second malicious device 830b may also include a processor 803d, a cryptographic module 812d, a bounding layer 816d and a physical layer 814d.

The verifier device 802 and the target device 804 may establish a shared key 822a,b. This may be accomplished as described in connection with FIG. 1. This may be performed in the presence of the first malicious device 830a and the second malicious device 830b.

In the event of a relay attack, the two malicious devices 830a,b can pass the encrypted value(s) of the encrypted bounding sequence ({N}_{K}) 824 from the verifier device 802 to the target device 804. Since this scheme provides for the use of multiple values of the processing time multiplier 118, which can be randomly determined then encrypted prior to transmission, it is possible to further strengthen distance bounding because it is no longer possible for a malicious device 830 to know the sequence of processing time multipliers 118 that will be used for any transaction.

In an implementation, the verifier device 802 may generate a bounding sequence 810a. The bounding sequence 810b may be provided to the bounding layer 816a, which may provide the bounding sequence 810c to the cryptographic module 812a.

The cryptographic module 812a may encrypt the bounding sequence 810 using the shared key (K) 822c. The cryptographic module 812a may provide the encrypted bounding sequence ({N}_{K}) 824a to the physical layer 814a. In a relay attack, the physical layer 814a of the verifier device 802 may send the encrypted bounding sequence ({N}_{K}) 824b to the physical layer 814c of the first malicious device 830a. The first malicious device 830a may send the encrypted bounding sequence ({N}_{K}) 824d to the physical layer 814d of the second malicious device 830b, which forwards the encrypted bounding sequence ({N}_{K}) 824e to the physical layer 814b of the target device 804.

The physical layer 814b of the target device 804 may provide the encrypted bounding sequence ({N}_{K}) 824f to the cryptographic module 812b, which decrypts the bounding sequence 810d using the shared key 822d.

Because the verifier device 802 and the target device 804 use a channel providing security and integrity, the malicious devices 830a,b cannot eavesdrop or modify data on the channel without this being detected.

In particular, the first malicious device 830a cannot determine the value of the bounding sequence (N) 810 because it does not have the shared key (K) 822. The first malicious device 830a may provide the encrypted bounding sequence ({N}_{K}) 824c to its cryptographic module 812c, but without the shared key (K) 822, it cannot decrypt the bounding sequence 810. Because the malicious devices 830a,b cannot decrypt the bounding sequence (N) 810, the malicious devices 830a,b cannot determine the processing time multipliers 118 used for distance bounding, and distance bounding will fail.

FIG. 9 is a sequence diagram illustrating one approach to calculating transit time 934 by a verifier device 902. In this example, a verifier device 902 (e.g., reader/writer) communicates with a target device 904 (e.g., card). The verifier device 902 may be implemented in accordance with the verifier device 102 of FIG. 1. The target device 904 may be implemented in accordance with the target device 104 of FIG. 1.

The verifier device 902 may send 901 a challenge 126 to the target device 904. The amount of time for signals to travel between the verifier device 902 and the target device 904 is the transit time (T_{f}) 934. Therefore, the amount of time for the challenge 126 to arrive at the target device 904 is the transit time (T_{f}) 934a.

The target device 904 may process 903 the challenge 126. The amount of time to process the challenge 126 and generate a response 128 is the processing time (T_{proc}) 930. The target device 904 may send 905 the response 128 back to the verifier device 902. The amount of time for the response 128 to arrive at the verifier device 902 is the transit time (T_{f}) 934b. Assuming the distance 106 between the verifier device 902 and the target device 904 has not changed, the transit time (T_{f}) 934 a for the challenge 126 and the transit time (T_{f}) 934b for the response 128 are the same.

The round-trip time (T_{round,1}) 932 for the challenge/response exchange may be expressed according to Equation (1) above. In this example, the verifier device 902 can measure the round-trip time (T_{round,1}) 932 for the challenge/response exchange from the time the challenge 126 is sent to the time the response 128 is received. In other words, T_{round,1}=T_{proc}+2·T_{f}. However, because the verifier device 902 generally does not know the processing time (T_{proc}) 930, the verifier device 902 cannot accurately determine the transit time (T_{f}) 934 and, thus, the distance 106 to the target device 904.

FIG. 10 is a sequence diagram illustrating an approach for calculating transit time 1034 according to the described systems and methods. In this example, a verifier device 1002 communicates with a target device 1004. The verifier device 1002 may be implemented in accordance with the verifier device 102 of FIG. 1. The target device 1004 may be implemented in accordance with the target device 104 of FIG. 1. The verifier device 1002 may be a reader device (e.g., reader/writer), the target device 1004 may be a listening device (e.g., card).

The verifier device 1002 may measure a first round-trip time (T_{round,1}) 1032 for an exchange of a first challenge 126 and a first response 128. The verifier device 1002 may send 1001 the first challenge 126 to the target device 1004. The amount of time for the first challenge 126 to arrive at the target device 1004 is the transit time (T_{f}) 1034a.

The target device 1004 may start processing 1003 the challenge 126. The amount of time to process the challenge 126 and generate a response is the processing time (T_{proc}) 1030. The target device 1004 may send 1005 the first response 128 back to the verifier device 1002. The amount of time for the first response 128 to arrive at the verifier device 1002 is the transit time (T_{f}) 1034b.

The verifier device 1002 may measure a second round-trip time (T_{round,2}) 1036 for an exchange of a second challenge 126 and a second response 128. The verifier device 1002 may send 1007 the second challenge 126 to the target device 1004. The amount of time for the second challenge 126 to arrive at the target device 1004 is the transit time (T_{f}) 1034c.

The target device 1004 may delay 1009 processing the second challenge 126 based on a processing time multiplier (n) 118. In this example, the processing time multiplier (n) 118 equals 2. Therefore, the target device 1004 scales the processing time 1030 by a multiple of 2 before responding to the second challenge 126. In other words, the target device 1004 delays its response 128 by twice its internal processing delay. The processing time multiplier (n) 118 may be determined according to a bounding sequence 110 that is exchanged between the verifier device 1002 and the target device 1004, as described in connection with FIG. 1.

After the processing delay, the target device 1004 may send 1011 a second response 128 to the verifier device 1002. The amount of time for the second response 128 to arrive at the verifier device 1002 is the transit time (T_{f}) 1034d.

Once again, assuming the distance 106 between the verifier device 1002 and the target device 1004 has not changed, the transit times (T_{f}) 1034a-d are the same.

The verifier device 1002 now has two different round-trip times. The verifier device 1002 may determine the transit time measurement 1034 according to Equation (5). In this case, the processing time multiplier (n) 118 is 2. It should be noted that the transit time measurement 1034 does not require that the verifier device 1002 know the actual processing time 1030 of the target device 1004.

In this example, T_{round,1}=T_{proc}+2·T_{f} and T_{round,2}=2·T_{proc}+2·T_{f}. So 2·T_{round,1}=2·T_{proc}+4·T_{f}. Therefore, 2·T_{round,1}−T_{round,2}=2T_{f}. This gives T_{f}=(2·T_{round,1}−T_{round,2})/2.

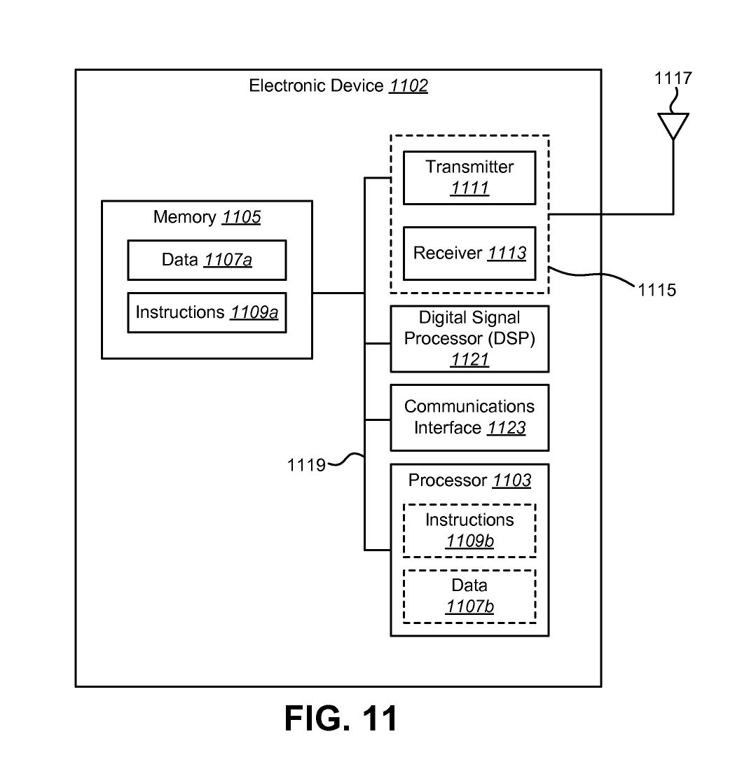

FIG. 11 illustrates certain components that may be included within an electronic device 1102. The electronic device 1102 may be an access terminal, a mobile station, a user equipment (UE), etc. For example, the electronic device 1102 may be the verifier device 102 or the target device 104 of FIG. 1.

The electronic device 1102 includes a processor 1103. The processor 1103 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 1103 may be referred to as a central processing unit (CPU). Although just a single processor 1103 is shown in the electronic device 1102 of FIG. 11, in an alternative configuration, a combination of processors (e.g., an ARM and DSP) could be used.

The electronic device 1102 also includes memory 1105 in electronic communication with the processor (i.e., the processor can read information from and/or write information to the memory). The memory 1105 may be any electronic component capable of storing electronic information. The memory 1105 may be configured as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 1107a and instructions 1109a may be stored in the memory 1105. The instructions may include one or more programs, routines, sub-routines, functions, procedures, code, etc. The instructions may include a single computer-readable statement or many computer-readable statements. The instructions 1109a may be executable by the processor 1103 to implement the methods disclosed herein. Executing the instructions 1109a may involve the use of the data 1107a that is stored in the memory 1105. When the processor 1103 executes the instructions 1109, various portions of the instructions 1109b may be loaded onto the processor 1103, and various pieces of data 1107b may be loaded onto the processor 1103.

The electronic device 1102 may also include a transmitter 1111 and a receiver 1113 to allow transmission and reception of signals to and from the electronic device 1102 via an antenna 1117. The transmitter 1111 and receiver 1113 may be collectively referred to as a transceiver 1115. The electronic device 1102 may also include (not shown) multiplier transmitters, multiplier antennas, multiplier receivers and/or multiplier transceivers.

The electronic device 1102 may include a digital signal processor (DSP) 1121. The electronic device 1102 may also include a communications interface 1123. The communications interface 1123 may allow a user to interact with the electronic device 1102.

The various components of the electronic device 1102 may be coupled together by one or more buses, which may include a power bus, a control signal bus, a status signal bus, a data bus, etc. For the sake of clarity, the various buses are illustrated in FIG. 11 as a bus system 1119.

In the above description, reference numbers have sometimes been used in connection with various terms. Where a term is used in connection with a reference number, this may be meant to refer to a specific element that is shown in one or more of the figures. Where a term is used without a reference number, this may be meant to refer generally to the term without limitation to any particular figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 2 and FIG. 3 can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method by a verifier device, comprising:
authenticating a target device;
establishing a shared key with the target device;
sending a bounding sequence encrypted with the shared key to the target device; and
performing a distance upper bound determination procedure with the target device based on the bounding sequence.

2. The method of claim 1, wherein the encrypted bounding sequence is sent to the target device over a secure channel upon authenticating the target device and establishing the shared key.

3. The method of claim 1, wherein the bounding sequence is a random value or a sequence of random values.

4. The method of claim 1, wherein a processing time multiplier for a target device response is determined by the bounding sequence or a transformation of the bounding sequence.

5. The method of claim 4, wherein the processing time multiplier indicates an amount of time that the target device delays responding to a challenge sent by the verifier device.

6. The method of claim 1, wherein the distance upper bound is an upper bound on the distance between the verifier device and the target device.

7. The method of claim 1, wherein performing the distance upper bound determination procedure comprises:
measuring a round-trip time to send a challenge to the target device and receive a response that is delayed by a processing time multiplier determined by the bounding sequence; and
calculating the distance upper bound using the measured round-trip time and the processing time multiplier.

8. The method of claim 1, wherein performing the distance upper bound determination procedure comprises:
measuring a first round-trip time to receive a first response from the target device corresponding to a first challenge sent to the target device;
measuring a second round-trip time to receive a second response from the target device corresponding to a second challenge sent to the target device, wherein the target device scales a processing time for the second response by a processing time multiplier indicated by the bounding sequence or a transformation of the bounding sequence;
determining a transit time measurement based on the first round-trip time, the second round-trip time and the processing time multiplier; and
determining the distance upper bound by multiplying the transit time measurement by the speed of light.

9. The method of claim 1, wherein a physical layer of the verifier device sends the encrypted bounding sequence and a bounding layer of the verifier device performs the distance upper bound determination procedure.

10. A verifier device, comprising:
a processor;
a memory in communication with the processor; and
instructions stored in the memory, the instructions executable by the processor to:
authenticate a target device;
establish a shared key with the target device;
send a bounding sequence encrypted with the shared key to the target device; and
perform a distance upper bound determination procedure with the target device based on the bounding sequence.

11. The verifier device of claim 10, wherein the encrypted bounding sequence is sent to the target device over a secure channel upon authenticating the target device and establishing the shared key.

12. The verifier device of claim 10, wherein the bounding sequence is a random value or a sequence of random values.

13. The verifier device of claim 10, wherein a processing time multiplier for a target device response is determined by the bounding sequence or a transformation of the bounding sequence.

14. The verifier device of claim 13, wherein the processing time multiplier indicates an amount of time that the target device delays responding to a challenge sent by the verifier device.

15. The verifier device of claim 10, wherein the distance upper bound is an upper bound on the distance between the verifier device and the target device.

16. The verifier device of claim 10, wherein the instructions executable to perform the distance upper bound determination procedure comprise instructions executable to:
measure a round-trip time to send a challenge to the target device and receive a response that is delayed by a processing time multiplier determined by the bounding sequence; and
calculate the distance upper bound using the measured round-trip time and the processing time multiplier.

17. The verifier device of claim 10, wherein the instructions executable to perform the distance upper bound determination procedure comprise instructions executable to:
measure a first round-trip time to receive a first response from the target device corresponding to a first challenge sent to the target device;
measure a second round-trip time to receive a second response from the target device corresponding to a second challenge sent to the target device, wherein the target device scales a processing time for the second response by a processing time multiplier indicated by the bounding sequence or a transformation of the bounding sequence;
determine a transit time measurement based on the first round-trip time, the second round-trip time and the processing time multiplier; and
determine the distance upper bound by multiplying the transit time measurement by the speed of light.

18. A method by a target device, comprising:
authenticating a verifier device;
establishing a shared key with the verifier device;
receiving a bounding sequence encrypted with the shared key from the verifier device; and
performing a distance upper bound determination procedure with the verifier device based on the bounding sequence.

19. The method of claim 18, wherein the encrypted bounding sequence is received from the verifier target device over a secure channel upon authenticating the verifier device and establishing the shared key.

20. The method of claim 18, further comprising decrypting the bounding sequence using the shared key.

21. The method of claim 18, further comprising determining a processing time multiplier for the target device response based on the bounding sequence or a transformation of the bounding sequence.

22. The method of claim 21, wherein the processing time multiplier indicates an amount of time that the target device delays responding to a challenge received from the verifier device.

23. The method of claim 18, wherein performing the distance upper bound determination procedure comprises:
receiving, from the verifier device, a challenge that is associated with a processing time multiplier determined by the bounding sequence or a transformation of the bounding sequence; and
sending, to the verifier device, a response that is delayed by the processing time multiplier.

24. The method of claim 18, wherein a physical layer of the target device receives the encrypted bounding sequence and a bounding layer of the target device performs the distance upper bound determination procedure.

25. A target device, comprising:
a processor;
a memory in communication with the processor; and
instructions stored in the memory, the instructions executable by the processor to:
authenticate a verifier device;
establish a shared key with the verifier device;
receive a bounding sequence encrypted with the shared key from the verifier device; and
perform a distance upper bound determination procedure with the verifier device based on the bounding sequence.

26. The target device of claim 25, wherein the encrypted bounding sequence is received from the verifier target device over a secure channel upon authenticating the verifier device and establishing the shared key.

27. The target device of claim 25, further comprising instructions executable to decrypt the bounding sequence using the shared key.

28. The target device of claim 25, further comprising instructions executable to determine a processing time multiplier for the target device response based on the bounding sequence or a transformation of the bounding sequence.

29. The target device of claim 28, wherein the processing time multiplier indicates an amount of time that the target device delays responding to a challenge received from the verifier device.

30. The target device of claim 25, wherein the instructions executable to perform the distance upper bound determination procedure comprise instructions executable to:
receive, from the verifier device, a challenge that is associated with a processing time multiplier determined by the bounding sequence or a transformation of the bounding sequence; and
send, to the verifier device, a response that is delayed by the processing time multiplier.
